(19) United States
(12) Patent Application Publication
(10) Pub. No.: US 2007/0266904 A1
(43) Pub. Date: Nov. 22, 2007

(54) Building element composed by non recyclable elements

(76) Inventor: Eduardo Jara Marti, Puerto Montt (CL)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 11/647,596

(22) Filed: Dec. 29, 2006

(30) Foreign Application Priority Data
Dec. 30, 2005 (CL) 3493-2005

(51) Int. Cl. C04B 28/04; C04B 7/02; C09K 17/40; D01D 5/00

(52) U.S. Cl. 106/713; 106/287.17; 264/210.1

(57) ABSTRACT

Construction element of different forms, e.g. paving stone, blocks, floor tiles, coatings, bricks, pallet, panels, platforms among others, CHARACTERIZED in that it is composed mainly by non-recyclable waste material, preferably multilayer elements which generally take up space in landfills and dumping grounds. Such non-recyclable materials comprise a combination of any of the elements as aluminum, paper, polyamide, polyester, polypropylene, cork, paper and even marc or any other inert matter.

The present patent application for invention relates to a construction element manufactured from waste materials. Specifically, it relates to a construction element that may have the shape of a paving stone, brick, floor tile, slate stone, pallet, panel, platform, etc., which is manufactured from non-recyclable waste materials, i.e., from those materials that only take up space in landfills or dumping grounds in the cities.

### BACKGROUND

Currently, there are different construction material options of construction materials, especially concrete blocks or bricks, manufactured from an agglomeration of cement and a recycled material. The latter are preferably plastic materials, glass and generally every type of monolayer material which, by definition, if they are not used for their own recycling they are used in the aforementioned blocks.

On the other hand, the problem caused by the significant accumulation of non-recyclable multilayer materials in landfills is an environmental threat which have not been solved yet in most cities in the world. When we talk about multilayer materials we are referring to those non-recyclable materials that have more than one component in their composition, e.g., the combination of polyester and polyamide, aluminum and paper, and other compositions that can not be recyclable.

Chilean patent application 2099-1999, abandoned, equivalent to U.S. Pat. No. 6,329,437 relates to a material for universal construction used in construction engineering that includes recycled plastic waste materials to manufacture products containing such material and the related method to manufacture it. It is clear that this situation shows us the use of recycled plastic waste which could perfectly have been used in other functions such as its own recycling.

Patent WO 01/14277 publication relates to a concrete block that has recycled glass within its composition. Likewise, Japanese Patent JP 200236240 encompasses a process for manufacturing a light weight material block for its use in civil engineering and construction materials. The use of recycled plastic material from all kind of rough materials, in combination with cement base elements is disclosed in this publication. Finally, Canadian Patent CA 2145823 mentions the possibility of manufacturing different types of construction objects in the shape of paving stone or blocks using different types of components such as recycled plastic materials, metals, natural stones, glass and even cork which are appropriately inserted and molded for manufacturing the construction object.

All the above mentioned patent publications have in common the use of recyclable materials in their structure or formulation composition of construction objects. This means that if these materials are not used for what they have been intended to, they can perfectly be recycled as raw material to be reused and accomplish their original function. In turn, the present invention encompasses the unsolved problem of integrally using in its composition non-recyclable materials without the need to use cement materials or primary binders although they can be used alternatively. For this reason, it is not only possible to obtain a construction element made from non-recyclable materials but also to help the environment when using materials that only take up space and pollute the environment.

Another advantage of the present application is the fact that non-recyclable materials which form the construction element can come from different places regardless the multilayer composition that form them. In this regard, the construction element of the invention can be manufactured from flanges or scrap of plastic materials used in companies that manufacture packaging or wrapping for all sorts of industry, combined with multilayer elements such as aluminum-paper, polyamide, polyester, polyethylene, pvc, etc.

Thus, the construction element of the present invention always comprises polyamide, paper and polyethylene, among others, in order to achieve the sufficient structure to be molded in the desired final shape.

### BRIEF DESCRIPTION OF THE FIGURE

FIG. 1 corresponds to a diagram of the construction element manufacturing process of the present invention.

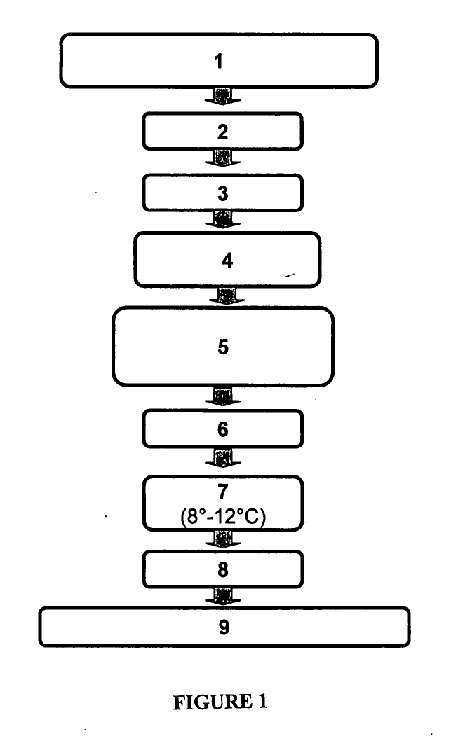

### DETAILED DESCRIPTION OF THE INVENTION

The construction element is manufactured with non-recyclable waste materials, preferably multilayer elements comprising aluminum, paper, polyamide, polyester, polypropylene, cork, where obviously in such multilayer material at least two of the aforementioned materials are present, since they would be recyclable elements by themselves. For example, the combination of these materials with plastic material flanges or scrap for packaging, gives a construction element the necessary resistance, flexibility and durability. The manufacturing process starts by recovering the non-recyclable waste material which comes from landfills or factory discharge. The use of nylon, yoghurt containers, adhesive materials, tetra pak type packages, soda cans among others, can be mentioned within the factory discharge. Also, it can be appreciated in the following table which shows different compositions that also marc has been used to originate a construction element.

All the above mentioned materials are received at the entrance of the processing plant and are packed (1) having the precaution to calculate the amount present of each type of non-recyclable waste before packing to obtain at the end of the process line the desired construction element features to be formulated. Once packed, the material is grinded in grinders to obtain a finely cut material.

After the grinding step (2), the finely cut material undergoes a melting and binding step by extrusion at controlled temperatures so all the materials present can form a perfectly bound base matter (3). The melting and first extrusion temperature ranges from 140 to 250° C.

Regarding temperature, the materials are provided with their melting point common features so that they are proportionally bound. As it has been mentioned, such proportion is determined when the material is delivered at the plant, and undergoes the packing step (1) with the complete composition.

The bound material that is obtained in the described melting step has the shape of small noodles that are cut when the dough starts to chill to form small pellets. These small pellets are the base raw material for obtaining the final construction element, and are processed according to the required shape.

Then the pellets are melted (4) and mixed in this step with coloring materials well known in the prior art to give color to plastic materials, usually called masterbatch. The resulting melted dough, now with the color already impregnated, undergoes a molding step (5) where it is given the desired final shape, for example, pallets to carry objects, roof tiles, paving stones, wall coatings, blocks, among others. Once the final shape is obtained, the construction element undergoes a weighing step (6) and then, only after the weight has been verified, the element is cooled (7) at a temperature from 5 to 15° C. After the material is cooled, the possible excess material is removed (8) in order to give a high quality finish to the obtained final element (9).

The excess material is reused as raw material at the beginning of the manufacturing process of the construction element described herein.

By way of illustration, the construction element may have different proportions of the materials that form them. Different combinations that a specific construction element may have are shown in table 1 only as an illustrative way. It is understood that the scope of the invention is not limited to other proportions of the final composition of a particular element.

TABLE 1
Raw Material: non-recyclable compound materials
(Each component may vary up to 10% and PE may vary up to 20%)
CONSTRUCTION ELEMENT COMPOSITION

| | BASE | 1 | 2 | 3 | 4 | 5 | 6 | 8 | 9 | 10 | 11 | 12 | 13 | 14 | 15 | 7 |
|---|---|---|---|---|---|---|---|---|---|---|---|---|---|---|---|---|
| | 100.0 | 100.0 | 100.0 | 100.0 | 100.0 | 100.0 | 100.0 | 100.0 | 100.0 | 100.0 | 100.0 | 100.0 | 100.0 | 100.0 | 100.0 | 100.0 |
| PA * | 2.9 | 1.8 | 1.6 | 1.5 | 1.5 | 1.7 | 1.5 | 1.7 | 2.0 | 2.4 | 2.1 | 2.2 | 2.6 | 2.3 | 2.7 | 1.4 |
| PE * | 58.0 | 35.8 | 32.0 | 29.2 | 29.4 | 33.7 | 30.8 | 33.9 | 40.0 | 48.8 | 42.6 | 43.0 | 52.6 | 46.0 | 53.3 | 28.0 |
| PAPER * | 29.0 | 17.9 | 16.0 | 14.6 | 14.7 | 16.8 | 15.4 | 17.0 | 20.0 | 24.4 | 21.3 | 21.5 | 26.3 | 23.0 | 26.7 | 14.0 |
| OTHERS * | 10.1 | 6.3 | 5.6 | 5.1 | 5.2 | 5.9 | 5.4 | 5.9 | 7.0 | 8.5 | 7.4 | 7.5 | 9.2 | 8.0 | 9.3 | 4.9 |
| MARC | | 38.3 | 34.3 | 31.3 | 31.5 | 36.1 | 33.0 | 36.4 | | | | | | | | 30.0 |
| AL | | | | 13.2 | 13.2 | | 13.9 | | 18.0 | | 19.1 | 19.4 | | 20.7 | | 12.6 |
| PET | | | 4.8 | | 4.4 | | | 5.1 | 6.0 | 7.3 | | 6.5 | | | 8.0 | 4.2 |
| PP | | | 5.6 | 5.1 | | 5.9 | | | 7.0 | 8.5 | 7.4 | | 9.2 | | | 4.9 |

* Materials present in base formulation
PA: Polyamide
PE: Polyethylene
Al: Aluminum
PET: Polyester
PP: Polypropylene

As it is shown in Table 1, mainly in all kinds of construction elements materials such as polyamide, polyester, paper and plastic in general are present because such elements are common in non-recyclable multilayer materials. Additionally, tests have been carried out where alternatively in the final stage, cement elements, small stones and ceramic have been used in the paving stone composition as well as different size gravel to give a different look to a paving stone type element.

All the above information is aimed to represent the invention in a illustrative way, but it will be understood that a skillful average level technician may introduce technically designed equivalent elements in order to accomplish the same function as those previously disclosed within the invention and without altering the solution disclosed herein, and therefore, are intended to fall in the scope of the protection of the present invention.

The entire disclosures of all applications, patents and publications, cited herein and of corresponding Chilean application No. 3493-2005, filed Dec. 30, 2005 is incorporated by reference herein.

The preceding examples can be repeated with similar success by substituting the generically or specifically described reactants and/or operating conditions of this invention for those used in the preceding examples.

From the foregoing description, one skilled in the art can easily ascertain the essential characteristics of this invention and, without departing from the spirit and scope thereof, can make various changes and modifications of the invention to adapt it to various usages and conditions.

What is claimed is:

1. A construction element, containing non-recyclable waste material comprising a combination of any of aluminum, paper, polyamide, polyester, polyehtylene, polypropylene, cork, paper or marc.

2. An element according to claim 1, wherein the non-recyclable waste material is a multilayer element.

3. An element according to claim 1, wherein the non-recyclable material is present in a proportion according to one of compositions 1-15 of the following table:
CONSTRUCTION ELEMENT COMPOSITION

| | BASE | 1 | 2 | 3 | 4 | 5 | 6 | 8 | 9 | 10 | 11 | 12 | 13 | 14 | 15 | 7 |
|---|---|---|---|---|---|---|---|---|---|---|---|---|---|---|---|---|
| | 100.0 | 100.0 | 100.0 | 100.0 | 100.0 | 100.0 | 100.0 | 100.0 | 100.0 | 100.0 | 100.0 | 100.0 | 100.0 | 100.0 | 100.0 | 100.0 |
| PA * | 2.9 | 1.8 | 1.6 | 1.5 | 1.5 | 1.7 | 1.5 | 1.7 | 2.0 | 2.4 | 2.1 | 2.2 | 2.6 | 2.3 | 2.7 | 1.4 |
| PE * | 58.0 | 35.8 | 32.0 | 29.2 | 29.4 | 33.7 | 30.8 | 33.9 | 40.0 | 48.8 | 42.6 | 43.0 | 52.6 | 46.0 | 53.3 | 28.0 |
| PAPER * | 29.0 | 17.9 | 16.0 | 14.6 | 14.7 | 16.8 | 15.4 | 17.0 | 20.0 | 24.4 | 21.3 | 21.5 | 26.3 | 23.0 | 26.7 | 14.0 |
| OTHERS * | 10.1 | 6.3 | 5.6 | 5.1 | 5.2 | 5.9 | 5.4 | 5.9 | 7.0 | 8.5 | 7.4 | 7.5 | 9.2 | 8.0 | 9.3 | 4.9 |
| MARC | | 38.3 | 34.3 | 31.3 | 31.5 | 36.1 | 33.0 | 36.4 | | | | | | | | 30.0 |
| AL | | | | 13.2 | 13.2 | | 13.9 | | 18.0 | | 19.1 | 19.4 | | 20.7 | | 12.6 |
| PET | | | 4.8 | | 4.4 | | | 5.1 | 6.0 | 7.3 | | 6.5 | | | 8.0 | 4.2 |
| PP | | | 5.6 | 5.1 | | 5.9 | | | 7.0 | 8.5 | 7.4 | | 9.2 | | | 4.9 |

* Materials present in base formulation
wherein:
PA is polyamide, PE is polyethylene, AL is aluminum, PET is polyester and PP is polypropylene, wherein PA, PE, paper and “others” are inert materials bringing the composition to 100%.

4. An element according to claim 1, in the form of a paving stone, slate stone, blocks, floor tiles, coatings, bricks, pallet, panels or platforms.

5. An element according to claim 1, comprising cement.

6. An element according to claim 1, comprising gravel.

7. An element according to claim 1 comprising a ceramic.

8. A process for preparation of a construction element comprising:
a) recovering non-recyclable waste material;
b) sorting and packing said material;
c) grinding packed material to obtain a finely cut material;
d) melting and binding said finely cut material by extruding the melting in order to form small noodles;
e) cutting such small noodles to form small pellets as base raw material;
f) melting such pellets and optionally mixing them with dying materials in order to form a dough optionally with the color already impregnated; and
g) molding such dough to give a final desired shape to the construction element.

9. A process for manufacturing a construction element according to claim 8, wherein such construction element in final shape is weighed and cooled at a temperature from 5 to 15° C.

10. A process for manufacturing a construction element according to claim 8, wherein d) melting ground material is carried out at a temperature of 140 to 250° C.

11. A process for manufacturing a construction element according to claim 8, wherein before packing waste elements, the amount of each element present is calculated in order to pack the final formulation of the construction material.

12. A process for manufacturing a construction element according to claim 8, wherein the construction element is cooled, and retouched to remove any materials and to finish such element.

13. A process for manufacturing a construction element according to claim 9 wherein excess material is reused at the beginning of the process.

14. A process for manufacturing a construction element according to claim 8, wherein non-recyclable waste materials comprise aluminum, paper, polyamide, polyester, polypropylene, cork, polyethylene or marc.

15. A process according to claim 8, wherein the element is in the form of a paving stone, slate stone, blocks, floor tiles, coatings, bricks, pallets, panels or platforms.

16. A construction element prepared by a process according to claim 8.

17. A construction element prepared by a process according to claim 19.

18. A construction element prepared by a process according to claim 12.

19. A construction element prepared by a process according to claim 14.

20. A construction element prepared by a process according to claim 15.
